(19) United States
(12) Patent Application Publication
(10) Pub. No.: US 2008/0077675 A1
(43) Pub. Date: Mar. 27, 2008

(54) Systems and Methods for Electronic Message Preparation

(75) Inventor: Nils Graef, Santa Clara, CA (US)

Correspondence Address: HAMILTON AND DESANCTIS, 8555 W. BELLEVIEW AVE., LITTLETON, CO, 80123, US

(73) Assignee: Agere Systems Inc.

(21) Appl. No.: 11/534,731

(22) Filed: Sep. 25, 2006

(51) Int. Cl. G06F 15/16

(52) U.S. Cl. 709/206

(57) ABSTRACT

Various systems and methods for electronic message generation are disclosed herein. For example, one method is disclosed that includes receiving a portion of an electronic message that in some way identifies a recipient of the electronic message. The electronic message may be, but is not limited to, an email message or a text message. The method further includes accessing a recipient database that includes information associated with the recipient along with one or more other recipients. From the recipient database a recipient message portion associated with the identified recipient is retrieved, and the portion of the electronic message is augmented with the recipient message portion associated with the recipient.

### BACKGROUND OF THE INVENTION

The present invention is related to systems and methods for creating electronic messages, and more particularly to systems and methods for incorporating predefined segments within electronic messages.

Electronic messaging including text messages, instant messages and emailing has in many ways replaced old style physical messaging such as telephone calls and physical mail. Indeed, some experts estimate that ten billion or more electronic messages are sent each day. In a typical scenario an electronic message is composed by providing a destination address for the electronic message along with the body of the text. Once the electronic message is composed, it is then transferred to the destination address where it may be accessed by a recipient. This process typically involves writing the recipients name (or some indication thereof) twice. In particular, where an email is being sent, the recipient's email address is provided followed by a salutation that also includes the recipient's name. This is of course wasteful. Further, where there are more than one recipient, the process may not repeat each recipient's name in the salutation leaving what may appear to be an impersonal message to each of the recipients.

Hence, for at least the aforementioned reasons, there exists a need in the art for advanced systems and methods for generating and/or distributing electronic messages.

### BRIEF SUMMARY OF THE INVENTION

The present invention is related to systems and methods for creating electronic messages, and more particularly to systems and methods for incorporating predefined segments within electronic messages.

Various embodiments of the present invention provide methods for electronic message personalization. Such methods include receiving a portion of an electronic message that in some way identifies a recipient of the electronic message. The electronic message may be, but is not limited to, an email message or a text message. Based on the disclosure provided herein, one of ordinary skill in the art will recognize other types of electronic messages to which embodiments of the present invention may be applied. In some cases where the electronic message is an email message, the identity of the recipient may be derived from an email address of the recipient or the recipients name written in the body of the message. In other cases where the electronic message is a text message to be sent via a phone network, the identity of the recipient may be derived from a telephone number or a name of the recipient written in the body of the message. Based on the disclosure provided herein, one of ordinary skill in the art will recognize other approaches for identifying a recipient that may be used in relation to embodiments of the present invention. The aforementioned methods further include accessing a recipient database that includes information associated with the recipient along with one or more other recipients. From the recipient database a recipient message portion associated with the identified recipient is retrieved, and the portion of the electronic message is augmented with the recipient message portion associated with the recipient.

Some instances of the aforementioned embodiments further include sending an electronic message to the recipient that includes the portion of the electronic message and the recipient message portion. The recipient message portion may include, but is not limited to, a salutation message previously selected for the recipient. Such a salutation may be selected based on one or more criteria such as, for example, a time of day, a time of year general to many recipients, and a time of year specific to the recipient. A time of year general to many recipients may be, but is not limited to, a national holiday. In contrast, a time of year specific to the recipient may be, but is not limited to, the recipient's birthday. In some cases, a dismissal message may be chosen either in place of or in addition to the aforementioned salutation.

In various instances of the aforementioned embodiments, the portion of the electronic message is an email address of the recipient, and augmenting the portion of the electronic message with the recipient message portion associated with the recipient includes forming an email message to the recipient. In such cases, the email message to the recipient includes the recipient message portion associated with the recipient. In one particular instance of the aforementioned embodiments, multiple email messages are created based on multiple recipient addresses. This may be done, for example, in the situation where a reply email is requested to multiple recipients. In such cases, a salutation specific to each of the identified recipients may be selected, and respective emails tailored to each of the recipients may be generated and delivered.

Other embodiments of the present invention provide systems for automatic message generation. Such systems include a computer readable medium that includes instructions executable by a processor to receive a portion of an electronic message that identifies a recipient. The instructions are further executable to access a recipient database that includes information associated with the recipient along with one or more other recipients, and the recipient message portion associated with the recipient is retrieved. Further, the portion of the electronic message is augmented with the recipient message portion associated with the recipient. In such cases, the recipient message portion may be, but is not limited to, a salutation message previously selected for the recipient, a signature block previously selected for the recipient, and/or a dismissal previously selected for the recipient. Further, the portion of the electronic message may be, but is not limited to, a telephone number, an email address or a name of the recipient.

Yet other embodiments of the present invention provide methods for semi-automatically preparing personalized electronic messages. The methods include providing a recipient database; associating a first recipient identifier with a first recipient message portion in the recipient database; and associating a second recipient identifier with a second recipient message portion in the recipient database.

This summary provides only a general outline of some embodiments according to the present invention. Many other objects, features, advantages and other embodiments of the present invention will become more fully apparent from the following detailed description, the appended claims and the accompanying drawings.

### BRIEF DESCRIPTION OF THE DRAWINGS

A further understanding of the various embodiments of the present invention may be realized by reference to the figures which are described in remaining portions of the specification. In the figures, like reference numerals are used throughout several drawings to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components

FIG. 1 is a flow diagram depicting a method for electronic message generation in accordance with one or more embodiments of the present invention;

FIG. 2 depicts a message generation system in accordance with various embodiments of the present invention; and

FIG. 3 is a flow diagram depicting another method for electronic message generation in accordance with other embodiments of the present invention.

### DETAILED DESCRIPTION OF THE INVENTION

The present invention is related to systems and methods for creating electronic messages, and more particularly to systems and methods for incorporating predefined segments within electronic messages.

Various embodiments of the present invention provide methods for electronic message personalization and/or generation. Such methods include receiving a portion of an electronic message that in some way identifies a recipient of the electronic message. As used herein, the phrase “electronic message” is used in its broadest sense to mean any message that is generated in an electronic form. This may include, for example, an email message, a text message, an instant message, or the like. Based on the disclosure provided herein, one of ordinary skill in the art will recognize other types of electronic messages to which embodiments of the present invention may be applied. Also, as used herein, the phrase “a portion of an electronic message” is used in its broadest sense to mean any subset of an electronic message. In some cases where the electronic message is an email message, the identity of the recipient may be derived from an email address of the recipient or the recipients name written in the body of the message. In other cases where the electronic message is a text message to be sent via a phone network, the identity of the recipient may be derived from a telephone number or a name of the recipient written in the body of the message. Based on the disclosure provided herein, one of ordinary skill in the art will recognize other approaches for identifying a recipient that may be used in relation to embodiments of the present invention. The aforementioned methods further include accessing a recipient database that includes information associated with the recipient along with one or more other recipients. From the recipient database a recipient message portion associated with the identified recipient is retrieved, and the portion of the electronic message is augmented with the recipient message portion associated with the recipient. As used herein, the phrase “a recipient message portion” is used in its broadest sense to mean a message segment that is in some way associated with a recipient or a particular group of recipients. Such recipient message portions may include, but are not limited to, a salutation message or a dismissal message previously selected for the recipient. Such a salutation may be selected based on one or more criteria such as, for example, a time of day, a time of year general to many recipients, and a time of year specific to the recipient. A time of year general to many recipients may be, but is not limited to, a national holiday. In contrast, a time of year specific to the recipient may be, but is not limited to, the recipient's birthday. In some cases, a dismissal message may be chosen either in place of or in addition to one of the aforementioned salutations.

In various instances of the aforementioned embodiments, the portion of the electronic message is an email address of the recipient, and combining the portion of the electronic message with the recipient message portion associated with the recipient to create an email message to the recipient. In one particular instance of the aforementioned embodiments, multiple email messages are created based on multiple recipient addresses. This may be done, for example, in the situation where a reply email is requested to multiple recipients. In such cases, a salutation specific to each of the identified recipients may be selected, and respective emails tailored to each of the recipients may be generated and delivered.

Other embodiments of the present invention provide systems for automatic message generation. Such systems include a computer readable medium that includes instructions executable by a processor to receive a portion of an electronic message that identifies a recipient. As used herein, the phrase “computer readable medium” is used in its broadest sense to mean any storage medium accessible to a computer. Thus, for example, a computer readable medium may be, but is not limited to, a CD-ROM, a random access memory, a hard disk drive, an optical drive, flash memory, and/or combinations of the aforementioned. Based on the disclosure provided herein, one of ordinary skill in the art will recognize a myriad of other computer readable media that may be used in relation to one or more embodiments of the present invention. The instructions are further executable to access a recipient database that includes information associated with the recipient along with one or more other recipients, and the recipient message portion associated with the recipient is retrieved. Further, the portion of the electronic message is augmented with the recipient message portion associated with the recipient. In such cases, the recipient message portion may be, but is not limited to, a salutation message previously selected for the recipient, a signature block previously selected for the recipient, and/or a dismissal previously selected for the recipient. Further, the portion of the electronic message may be, but is not limited to, a telephone number, an email address or a name of the recipient.

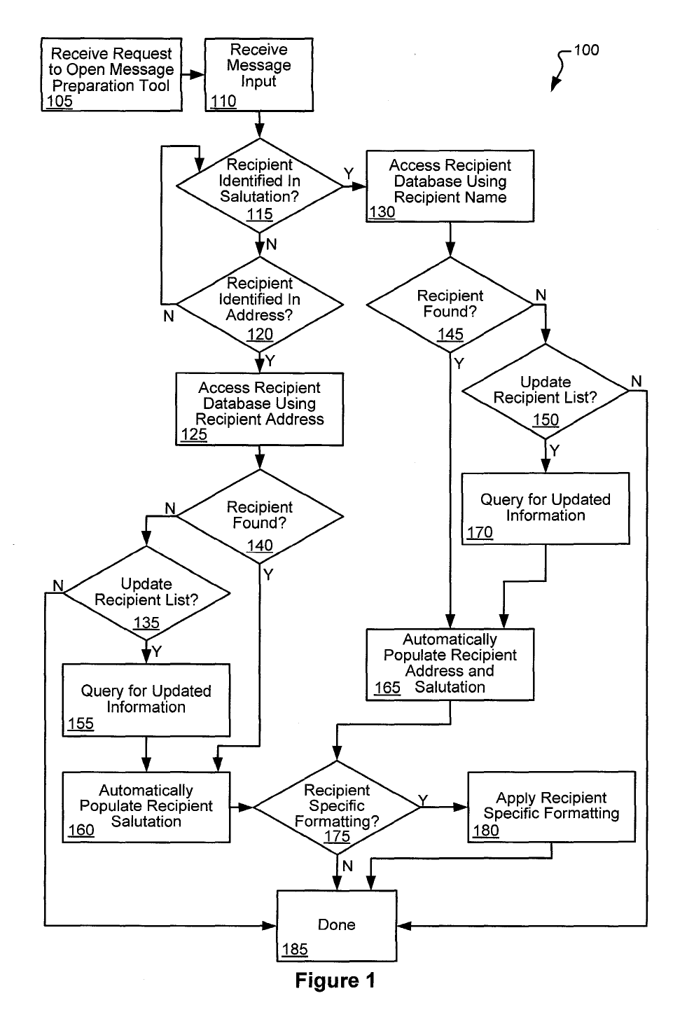

Turning to FIG. 1, a flow diagram 100 depicts a method for electronic message generation in accordance with one or more embodiments of the present invention. Following flow diagram 100, a request to open a message preparation tool is received (block 105). The message preparation tool may be an editor associated with an email tool, a text message tool, an instant messenger, or the like. A message is then input into the message preparation tool (block 105). As the message is input into the message preparation tool (block 1 10), the message is analyzed to determine whether a recipient is identified in the body of the message (block 115) or in the address of the message (block 120). The process of determining whether a recipient has been identified in a portion of an electronic message is repeated until a recipient is identified. Thus, for example, a person may begin typing an email that proceeds as follows:

email address:
email message: Hi Joe ...

Once the electronic message portion “Joe” is identified in the text of the email, the recipient has been identified in the salutation (block 115). As an example, sufficient information to identify a recipient may be considered to have been received where one or two space separated words have been received after a typical salutation. For example, the phrase “Hello Joe” may be considered sufficient to provide the recipient identification “Joe” that is in turn used to access the recipient database. Alternatively, the phrase “How are you Joe Brown” may be considered sufficient to provide the recipient identification Joe Brown that is in turn used to access the recipient database. As yet another alternative, a unique symbol or phrase may be created to alert the program of an incoming recipient identification. Thus, for example, a user may input the phrase “RCP1” indicating that the following one word is a recipient identification, or use the phrase “RCP2” indicating that the following two words comprise a recipient identification. Thus, for example, providing “RCP1 Joe Brown” would cause “Joe” to be used as a recipient identification, while providing “RCP2 Joe Brown” would cause “Joe Brown” to be used as a recipient identification. As yet another alternative, the message may simply be repeatedly queried until a match in the recipient database is found. Based upon the disclosure provided herein, one of ordinary skill in the art will recognize a myriad of approaches that may be used in accordance with one or more embodiments of the present invention to identify a potential recipient identification.

Where the recipient has been thus identified, a recipient database is accessed using the electronic message portion (block 130). Where the electronic message portion has not provided sufficient information to uniquely identify a recipient within the recipient database, the process is returned to block 115 to await the input of additional information. Where the recipient identification is found in the recipient database (block 145), information from the recipient database that is associated with the recipient is retrieved from the recipient database and the retrieved information is used to populate the recipient address, recipient salutation, and/or recipient dismissal (block 165). Thus, following the preceding example of an email being written to Joe, the portion of the electronic message “Hi Joe” yields “Joe” as a recipient identifier that is used to access the recipient database. An exemplary recipient database is set forth in Table 1 below:

TABLE 1
Exemplary Recipient Database

| Recipient Identifier | Salutation | Dismissal | Address |
|---|---|---|---|
| Joe@xyz.com | Hello Joseph, I hope all | Best Regards, | N/A |
| | is going well today. | [Signature Block] | |
| Joe, Joseph, joe or | Hello Joseph, I hope all | Best Regards, | Joe@xyz.com |
| joseph | is going well today. | [Signature Block] | |
| Fred@abc.com | Howdy Fred, I hope | Sincerely your friend, | N/A |
| | everything finds you | [Signature Block] | |
| | well today. | | |
| Fred or fred | Howdy Fred, I hope | Sincerely your friend, | Fred@abc.com |
| | everything finds you | [Signature Block] | |
| | well today. | | |

Using the exemplary recipient database of Table 1, the salutation, dismissal and address may be used to automatically populate the email to create the following email shell:

email address: Joe@xyz.com
email message: Hello Joseph, I hope all is going well today.
{Message Body to be Completed by the User}
Best Regards,
[Signature Block]

In addition, there may some formatting specific to a particular recipient (block 175). For example, a given recipient may have poor eyesight in which case the message may be formatted using a sixteen point font. Alternatively, the recipient may have indicated a desire to save paper space on printed messages in which case the message may be formatted using a six point font. Based on the disclosure provided herein, one of ordinary skill in the art will recognize a variety of formatting that may be applied specifically to one or more recipients such as, but not limited to, backgrounds, fonts, colors and/or the like. Where formatting is selected (block 175), it is provided (block 180). Otherwise the process completes. With this process complete, all that remains is for the user to complete the remaining portions of the message to be communicated and to send the email. While the example is an email example, one of ordinary skill in the art will recognize that the same approach may be utilized in relation to other types of electronic messages.

Alternatively, where a recipient identification has been found (block 115) but it is not included in the recipient database (block 145), it is determined whether the recipient should be included in the recipient database (block 150). Where the recipient is to be included in the recipient database (block 150), information (e.g., the information from Table 1 above) is obtained by querying a user (block 170). The information is incorporated into the recipient database (not shown), and used to automatically generate the shell of a message as previously discussed (blocks 165, 175 and 180).

As another alternative, a user may first enter a recipient's address (block 120). This may be, for example, an email address for the recipient as follows:

email address: joe@xyz.com
email message:

Once the electronic portion joe@xyz.com is identified in the address line of the email, it may be used to access the exemplary recipient database set forth in Table 1 above (block 125). Where the recipient identification is found in the recipient database (block 140), information from the recipient database that is associated with the recipient is retrieved from the recipient database and the retrieved information is used to populate the recipient salutation and/or recipient dismissal (block 160). Thus, following the preceding example of an email being addressed to joe@xyz.com, the portion of the electronic message “joe@xyz.com” yields the automatically generated message set forth below:

email address: Joe@xyz.com
email message: Hello Joseph, I hope all is going well today.
{Message Body to be Completed by the User}
Best Regards,
[Signature Block]

In addition, there may be some formatting specific to a particular recipient (block 175). Where formatting is selected (block 175), it is provided (block 180). Otherwise the process completes. With this process complete, all that remains is for the user to complete the remaining portions of the message to be communicated and to send the email. Again, while the example is an email example, one of ordinary skill in the art will recognize that the same approach may be utilized in relation to other types of electronic messages.

Alternatively, where a recipient identification has been found (block 120) but it is not included in the recipient database (block 140), it is determined whether the recipient should be included in the recipient database (block 135). Where the recipient is to be included in the recipient database (block 135), information (e.g., the information from Table 1 above) is obtained by querying a user (block 155). The information is incorporated into the recipient database (not shown), and used to automatically generate the shell of a message as previously discussed (blocks 160, 175 and 180).

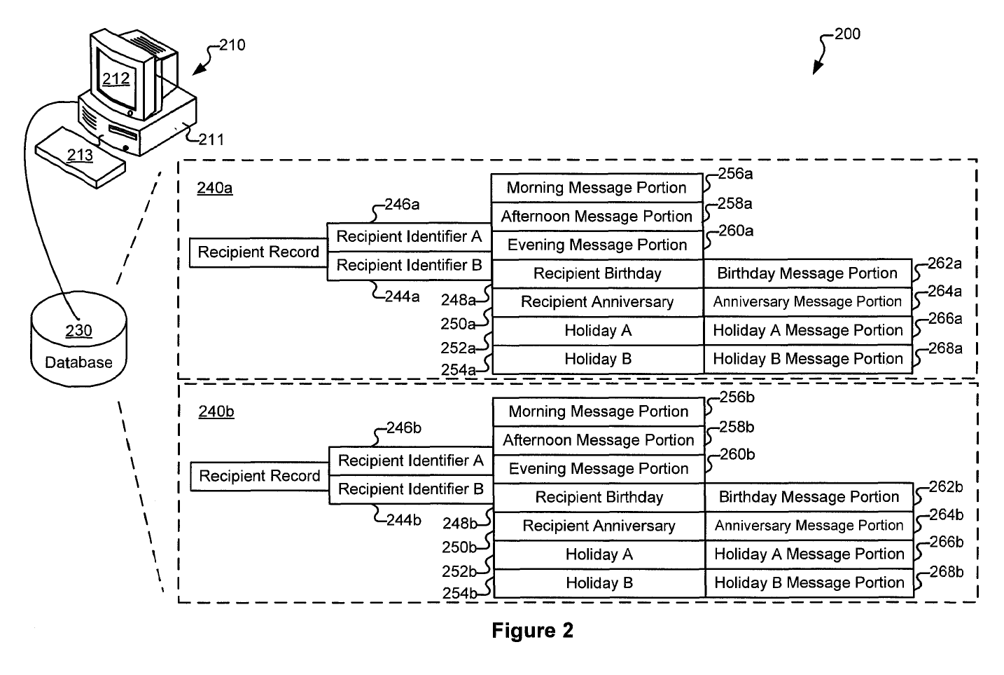

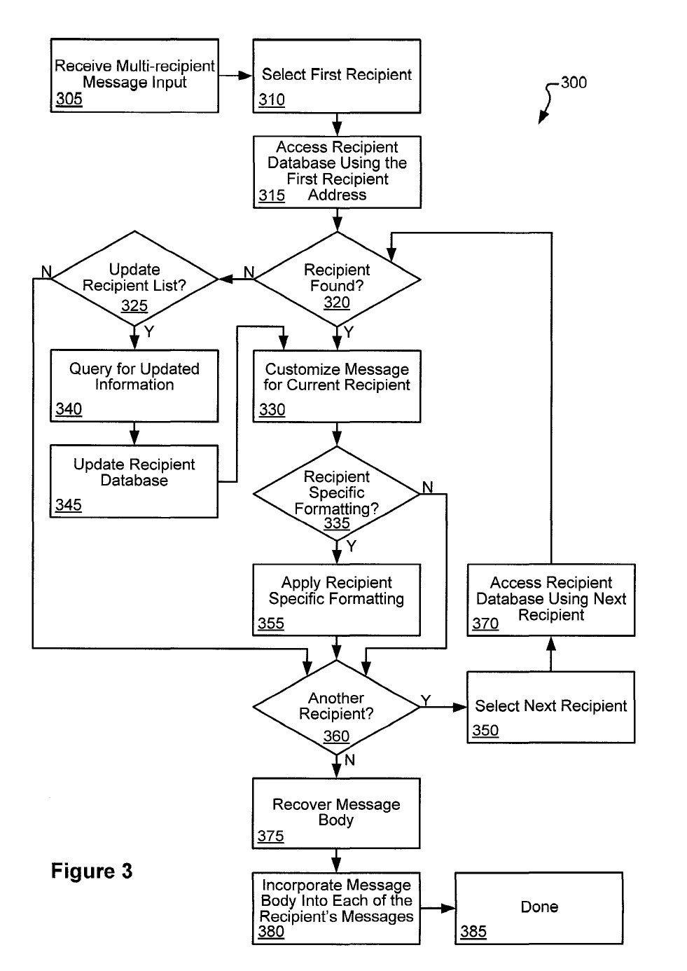

Turning to FIG. 2, a message generation system 200 in accordance with various embodiments of the present invention is depicted. Message generation system 200 includes a computer 210 with a processor based system 211, a display 212 and an input device 213. While the drawing generally suggests a personal computer, one of ordinary skill in the art will recognize that other processor based machines may be used in relation to different embodiments of the present invention. For example, computer 210 may be a personal digital assistant, a blackberry, a cellular telephone, a laptop computer, or the like. Computer 210 is associated with a computer readable medium (not shown) that includes a software program that is executable by computer 210 to generate messages in accordance with one or more embodiments of the present invention. For example, the computer readable medium may include instructions executable by computer 210 to perform message generation consistent with that discussed in relation to FIG. 1 above, and/or consistent with that discussed in relation to FIG. 3 below.

In addition, computer 210 is associated with a recipient database 230. Recipient database 230 includes a number of recipient records 240. Recipient records are similar to those set forth above in Table 1. Records 240 include one or more recipient identifiers 244, 246. These recipient identifiers may be any information that may be used to select a particular recipient record 240. Thus, for example, recipient identifiers 244, 246 may include, but are not limited to, a recipient's telephone number, a recipient's email address, a recipient's name, a recipient's instant messenger identification, or any other information indicative of a particular recipient. Recipient records 240 further include a number of criteria based message portions. The criteria based message portions may include, but are not limited to, a morning message portion 256 that may be used during morning hours, an afternoon message portion 258 that may be used during afternoon hours, and an evening message portion 260 that may be used during evening hours. Further, the criteria based message portions may include a time of year that is general to many recipients. For example, the criteria based message portions may include holiday indications 252, 254 along with a message portions associated with the respective holiday indications 266, 268. Thus, for example, holiday indication 252 may be associated with New Years day and indicates that it should be used anytime between December 28 and January 4. Yet further, the criteria based message portions may include a time of year specific to the recipient. For example, the criteria based message portions may include an indication of a recipient's birthday 248 along with a message portion to be used on or around the recipient's birthday 262; and/or an indication of a recipient's anniversary 250 along with a message portion to be used on or around the recipient's anniversary 264. Based on the disclosure provided herein, one of ordinary skill in the art will recognize a number of other criteria and/or criteria based messages that may be used in relation to one or more embodiments of the present invention.

In operation, when a particular criteria is met, the message portion associated with that criteria is incorporated into the message being generated. As an example, consider using the criteria based message portions set forth in Table 2 below:

TABLE 2
Exemplary Recipient Database Including Criteria Based Salutations

| Recipient | Salutations | | | |
|---|---|---|---|---|
| Identifiers | Criteria | Salutation | Dismissal | Address |
| Joe@xyz.com | (New Years | Happy New Year | Best | Joe@xyz.com |
| Joe, Joseph, | Holiday) | Joseph, I hope next | Regards, | |
| joe or joseph | Dates Between | year is at least as | [Signature | |
| | December 28 and | good as this. | Block] | |
| | January 4 | | Best | |
| | (Halloween) | Happy Halloween | Regards, | |
| | October 31 | Joseph, I hope your | [Signature | |
| | | holiday is going | Block] | |
| | | well. | | |
| | (Birthday) | Happy Birthday Big | | |
| | DATE | Joe, how many is it | | |
| | | this year? | | |
| | (Anniversary) | Happy Anniversary | | |
| | DATE | Joe —it is hard to | | |
| | | believe you still | | |
| | | work here. | | |
| | Morning | Good Morning | | |
| | Any day between | Joseph, | | |
| | hours of 5am and | | | |
| | 12 noon | | | |
| | Afternoon | Good Afternoon | | |
| | Any day between | Joseph, | | |
| | hours of 12 noon | | | |
| | and 6pm | | | |
| | Evening | Good Evening | | |
| | Any day between | Joseph, I hope your | | |
| | hours of 6pm and | day went well. | | |
| | 12 midnight | | | |
| | Default | Hi Joseph, | | |

It should be noted that Table 2 is merely exemplary and that many different record arrangements are possible in accordance with different embodiments of the present invention. For example, each criteria may also be associated with a criteria specific dismissal. Based on the disclosure provided herein, one of ordinary skill in the art will recognize a number of additional criteria and/or message portions.

In operation, the message ultimately generated will be determined by a particular criteria that is satisfied. In some cases, the criteria may not be mutually exclusive. For example, the recipient's birthday may fall within the above identified New Years season. In such cases, a general rule may be implemented to select between the criteria. In one particular case, the criteria listed first in the record is the criteria selected, while in other cases the more specific criteria is selected. Thus, for example, where the birthday falls within the identified New Years season, the New Years message is always used where the first listed criteria is the guiding criteria. Alternatively, where the more specific criteria controls, the birthday message is used during the specific birthday time and the New Years season message is used for the remaining part of the identified New Years seasons greeting. Based on the disclosure provided herein, one of ordinary skill in the art will recognize other approaches that may be used to arbitrate between selected criteria.

Using the previous example where the email address joe@xyz.com is entered, the following message would be generated using the record of Table 2 for a date falling in the New Years season:

email address: Joe@xyz.com
email message: Happy New Year Joseph, I hope next year is at least as
good as this.
{Message Body to be Completed by the User}
Best Regards,
[Signature Block]

Alternatively, where the date is October 31, the following message is generated:

email address: Joe@xyz.com
email message: Happy Halloween Joseph, I hope your holiday is
going well.
{Message Body to be Completed by the User}
Best Regards,
[Signature Block]

Alternatively, where the date is Joe's birth date, the following message is generated:

email address: Joe@xyz.com
email message: Happy Birthday Big Joe, how many is it this year?
{Message Body to be Completed by the User}
Best Regards,
[Signature Block]

Alternatively, where the date is Joe's Anniversary, the following message is generated:

email address: Joe@xyz.com
email message: Happy Anniversary Joe - it is hard to believe you
still work here.
{Message Body to be Completed by the User}
Best Regards,
[Signature Block]

Alternatively, where none of the dates are satisfied and the message is being sent between the hours of 5 am and noon, the following message is generated:

email address: Joe@xyz.com
email message: Good Morning Joseph,
{Message Body to be Completed by the User}
Best Regards,
[Signature Block]

Alternatively, where none of the dates are satisfied and the message is being sent between noon and 6 pm, the following message is generated:

email address: Joe@xyz.com
email message: Good Afternoon Joseph,
{Message Body to be Completed by the User}
Best Regards,
[Signature Block]

Alternatively, where none of the dates are satisfied and the message is being sent between the hours of 6 pm and midnight, the following message is generated:

email address: Joe@xyz.com
email message: Good Evening Joseph, I hope your day went well.
{Message Body to be Completed by the User}
Best Regards,
[Signature Block]

Alternatively, where none of the criteria are satisfied, the following message is generated:

email address: Joe@xyz.com
email message: Hi Joseph,
{Message Body to be Completed by the User}
Best Regards,
[Signature Block]

### The user may then complete the message with the specific information to be communicated, and then send the message.

Turning to FIG. 3, a flow diagram 300 depicts another method for electronic message generation in accordance with other embodiments of the present invention. Following flow diagram 300, a multi-recipient message input is received (block 305). A multi-recipient message is any message that is ultimately directed to multiple recipients. Thus, for example, in a common email scenario a user receives a message that was originally sent to many recipients and replies to all of the original recipients and the sender. In this case, there are multiple recipient identifications that are generated simultaneously (i.e., the email address of the original recipients and the original sender). In this case, the first recipient is selected (block 310), and the recipient database is accessed using the first recipient identification (block 315). It is determined whether a record for the first recipient is included in the recipient database (block 320). Where a record for the recipient is found (block 320), a message for the particular recipient is customized as previously discussed above in relation to blocks 160, 165 of FIG. 1 (block 330). It is then determined whether specific formatting is called set for the particular recipient (block 335). Where specific formatting is called for (block 335), it is applied (block 355). This may be done similar to that discussed above in relation to blocks 175, 180 of FIG. 1.

Alternatively, where a record for the identified recipient is not included in the recipient database (block 320), it is determined whether a record for the recipient is desired (block 325). Where a record is desired (block 325), a user is queried for information about the particular recipient (block 340) and any received information is used to create a record for the recipient in the recipient database (block 345). The received information may then be used to customize a message for the particular recipient and to apply any recipient specific formatting as discussed above in relation to blocks 330, 335, 355 of the figure currently being discussed.

Once the message for the first recipient is completed, it is determined if any other recipients exist (block 360). Where one or more other recipients remain (block 360), the next recipient is selected (block 350) and the recipient database is accessed using the next selected recipient (block 370). At this point, the processing of blocks 320-360 is repeated for the newly selected recipient. Once it is determined that no additional recipients remain to be processed (block 360), the user is queried to enter the message body that will be transmitted to all of the recipients (i.e., a response to an earlier email that is to be seen by all recipients) (block 375). This message body is then incorporated into each of the messages (block 380). At this point, the process ends (block 385) and the user is free to send the generated messages.

As previously discussed, the various embodiments of the present invention may be applied to a number of different electronic message types. Further, criteria specific salutations and dismissals may be generated. For example, a message may be tailored to have a dismissal of “Have Nice Weekend” where the message is sent after 2 pm on a Friday afternoon, or “Have a Safe 4^{th} of July Holiday” where the message is sent on July 3^{rd} or 4^{th}. The various embodiments of the present invention may also be used when composing scrapbook entries or comments on social networking websites, such as, MySpace.com™ or Orkut™. As known in the art, MySpace.com is a social networking website offering an interactive, user-submitted network of friends, personal profiles, blogs, groups, photos, music, and videos. MySpace also features an internal search engine and an internal e-mail system. Similarly, Orkut is an Internet social network service. It claims to be designed to help users meet new friends and maintain existing relationships by allowing members to create easy-to-setup simple forums (called “communities”) of users.

In conclusion, the present invention provides novel systems, devices, methods and arrangements for electronic message creation. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A method for electronic message generation, the method comprising:
receiving a portion of an electronic message, wherein the portion of the electronic message identifies a recipient;
accessing a recipient database, wherein the recipient database includes information associated with the recipient along with one or more other recipients, wherein a recipient message portion associated with the recipient is retrieved; and
augmenting the portion of the electronic message with the recipient message portion associated with the recipient.

2. The method of claim 1, wherein the method further comprises:
sending an electronic message to the recipient, wherein the electronic message includes the portion of the electronic message and the recipient message portion.

3. The method of claim 1, wherein the recipient message portion includes a salutation message previously selected for the recipient.

4. The method of claim 3, wherein the salutation message is one of a plurality of salutation messages associated with the recipient, and wherein the salutation message is selected from the plurality of salutation messages based on a criteria.

5. The method of claim 4, wherein the criteria is selected from a group consisting of: a time of day, a time of year general to many recipients, and a time of year specific to the recipient.

6. The method of claim 1, wherein the recipient message portion includes a dismissal message previously selected for the recipient.

7. The method of claim 1, wherein the portion of the electronic message is an email address.

8. The method of claim 7, wherein the email address is distilled from a request to reply to a received email.

9. The method of claim 1, wherein the portion of the electronic message is a telephone number.

10. The method of claim 1, wherein the portion of the electronic message is a name of the recipient.

11. The method of claim 1, wherein the portion of the electronic message is an email address of the recipient, and wherein augmenting the portion of the electronic message with the recipient message portion associated with the recipient includes forming an email message to the recipient, wherein the email message to the recipient includes the recipient message portion associated with the recipient.

12. The method of claim 11, wherein the email message is a first email message, wherein the recipient is a first recipient, wherein the recipient message portion is a first recipient message portion, wherein the email address of the recipient is a first email address associated with the first recipient, and wherein the method further comprises:
receiving a second email address associated with a second recipient;
accessing the recipient database, wherein a second recipient message portion associated with the second recipient is retrieved; and
forming a second email message to the second recipient, wherein the second email message to the second recipient includes the second recipient message portion associated with the recipient.

13. The method of claim 12, wherein the method further comprises:
sending the first email message to the first recipient; and
sending the second email message to the second recipient.

14. A system for semi-automatic message generation, the system comprising:
a computer readable medium, wherein the computer readable medium includes instructions executable by a processor to:
receive a portion of an electronic message, wherein the portion of the electronic message identifies a recipient;
access a recipient database, wherein the recipient database includes information associated with the recipient along with one or more other recipients, and wherein a recipient message portion associated with the recipient is retrieved; and
augment the portion of the electronic message with the recipient message portion associated with the recipient.

15. The system of claim 14, wherein the recipient message portion is selected from a group consisting of: a salutation message previously selected for the recipient, a signature block previously selected for the recipient, and a dismissal previously selected for the recipient.

16. The system of claim 15, wherein the portion of the electronic message is selected from a group consisting of: a telephone number, an email address and a name of the recipient.

17. A method for preparing semi-automatically personalized electronic messages, the method comprising:
providing a recipient database;
associating a first recipient identifier with a first recipient message portion in the recipient database; and
associating a second recipient identifier with a second recipient message portion in the recipient database.

18. The method of claim 17, wherein the first recipient message portion is a salutation message.

19. The method of claim 18, wherein the salutation message is associated with a criteria.

20. The method of claim 19, wherein the criteria is selected from a group consisting of: a time of day, a time of year general to many recipients, and a time of year specific to the recipient.
